(19) United States
(12) Patent Application Publication
(10) Pub. No.: US 2019/0297502 A1
(43) Pub. Date: Sep. 26, 2019

(54) METHOD AND APPARATUS FOR PERFORMING INTEGRITY VERIFICATION IN WIRELESS COMMUNICATION SYSTEM

(71) Applicant: LG Electronics Inc., Seoul (KR)

(72) Inventors: Geumsan JO, Seoul (KR); Bokyung BYUN, Seoul (KR); Seungjune YI, Seoul (KR)

(21) Appl. No.: 16/433,767

(22) Filed: Jun. 6, 2019

Related U.S. Application Data
(63) Continuation of application No. PCT/KR2019/001660, filed on Feb. 12, 2019.

(30) Foreign Application Priority Data
Mar. 22, 2018 (KR) 10-2018-0033466

(51) Int. Cl. H04W 12/10; H04W 76/11; H04W 80/08; H04W 88/02; H04L 9/32

(52) U.S. Cl. CPC H04W 12/1006; H04W 76/11; H04L 9/3242; H04W 88/023; H04W 80/08

(57) ABSTRACT

A method of reporting integrity verification failure by a user equipment (UE) in a wireless communication system. The method includes: receiving a data unit from a network; performing integrity verification using the data unit; and when the integrity verification fails, reporting information about the integrity verification failure to the network. The information about the integrity verification failure includes: (i) a radio bearer identity associated with the integrity verification failure, and (ii) at least one Packet Data Convergence Protocol (PDCP) COUNT value associated with the radio bearer identity.

### CROSS-REFERENCE TO RELATED APPLICATIONS

The present application is a continuation of International Application No. PCT/KR2019/001660, filed on Feb. 12, 2019, which claims the benefit of an earlier filing date and right of priority to Korean Application No. 10-2018-0033466, filed on Mar. 22, 2018. The disclosures of the prior applications are incorporated by reference in their entirety.

### TECHNICAL FIELD

The present disclosure generally relates to a wireless communication system.

### BACKGROUND

Introduction of new radio communication technologies has led to increases in the number of user equipments (UEs) to which a base station (BS) provides services in a prescribed resource region, and has also led to increases in the amount of data and control information that the BS transmits to the UEs. Due to typically limited resources available to the BS for communication with the UE(s), new techniques are needed by which the BS utilizes the limited radio resources to efficiently receive/transmit uplink/downlink data and/or uplink/downlink control information. In particular, overcoming delay or latency has become an important challenge in applications whose performance critically depends on delay/latency.

### SUMMARY

Implementations according to the present disclosure enable integrity verification in a wireless communication system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of reporting integrity verification failure by a user equipment (UE) in a wireless communication system, the method including: receiving a data unit from a network. The method of reporting integrity verification failure also includes performing integrity verification using the data unit. The method of reporting integrity verification failure also includes reporting information about the integrity verification failure to the network when the integrity verification fails. The method of reporting integrity verification failure also includes where the information about the integrity verification failure includes (i) a radio bearer identity associated with the integrity verification failure, and (ii) at least one packet data convergence protocol (PDCP) count value associated with the radio bearer identity. Other embodiments of this aspect include corresponding computer systems, apparatus, and computer programs recorded on one or more computer storage devices, each configured to perform the actions of the methods.

Implementations may include one or more of the following features. The method further including: incrementing a counter when the integrity verification failure occurs. The method may also include where reporting the information about the integrity verification failure includes reporting the information about the integrity verification failure to the network when the counter is equal to a threshold value. The method further including receiving information about the threshold value from the network. The method where the information about the integrity verification failure includes (i) at least one radio bearer identity, including the radio bearer identity, associated with the integrity verification failure, and (ii) at least one PDCP count value, including the PDCP count value, associated with the at least one radio bearer identity. The method where a cause of the integrity verification failure is determined by the network based on the at least one PDCP count value reported by the UE. The method where receiving the data unit from the network includes: receiving, through a lower layer of the UE, a PDCP protocol data unit (PDU). The method where performing the integrity verification using the data unit includes: determining a first value corresponding to a field of the data unit that was received from the network. The method may also include computing a second value based on at least one parameter provided by upper layers of the UE. The method may also include comparing the first value with the second value. The method may also include determining whether the integrity verification failure has occurred based on whether the first value is equal to the second value. The method where the first value is a value of a message authentication code for integrity (MAC-I) field of the data unit that was received from the network. The method may also include where the second value is a value of a computed MAC-I (X-MAC). The method where computing the second value based on the at least one parameter provided by the upper layers of the UE includes: computing the value of the x-mac based on at least one radio bearer identity and at least one key that are provided by the upper layers of the UE. Implementations of the described techniques may include hardware, a method or process, or computer software on a computer-accessible medium.

All or part of the features described throughout this disclosure can be implemented as a computer program product including instructions that are stored on one or more non-transitory machine-readable storage media, and that are executable on one or more processing devices. All or part of the features described throughout this disclosure can be implemented as an apparatus, method, or electronic system that can include one or more processing devices and memory to store executable instructions to implement the stated functions.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example of a network structure of an evolved universal mobile telecommunication system (E-UMTS) as an exemplary radio communication system;

FIG. 2 is a block diagram illustrating an example of an evolved universal terrestrial radio access network (E-UTRAN);

FIG. 3 is a block diagram depicting an example of an architecture of a E-UTRAN and a EPC;

FIG. 4 is a diagram showing an example of a control plane and a user plane of a radio interface protocol between a UE and an E-UTRAN;

FIG. 5 is a diagram showing an example of a physical channel structure used in an E-UMTS system;

FIGS. 6A and 6B illustrate examples of protocol stacks of a next generation wireless communication system;

FIG. 7 illustrates an example of a data flow example at a transmitting device in the NR system;

FIG. 8 illustrates an example of a slot structure available in a new radio access technology (NR);

FIG. 9 is a flow chart showing an example for performing integrity verification in a wireless communication system according to the implementations of the present disclosure; and

FIG. 10 is a block diagram illustrating an example of elements of a transmitting device 100 and a receiving device 200 according to some implementations of the present disclosure.

### DETAILED DESCRIPTION

Systems and techniques are disclosed herein that provide integrity verification in a wireless communication system. Implementations disclosed herein provide mechanisms for reporting integrity verification failures that enable detecting whether the integrity verification failure is caused by a security attack or by a Hyper Frame Number (HFN) de-synchronization.

In some scenarios, such implementations may provide an advantage that integrity verification failure may be reported more efficiently and with less ambiguity.

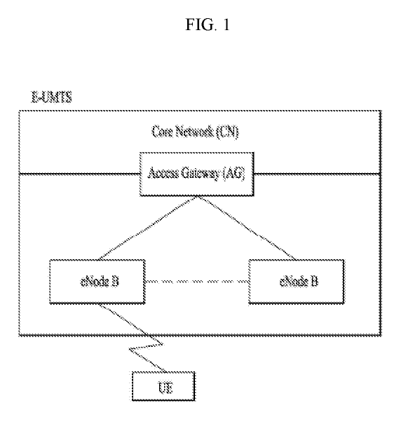

FIG. 1 is a diagram illustrating an example of a network structure that may be implemented in an Evolved Universal Mobile Telecommunications System (E-UMTS) as a radio communication system. An E-UMTS is an advanced version of a Universal Mobile Telecommunications System (UMTS). In some scenarios, E-UMTS may implement a Long Term Evolution (LTE) system.

Referring to the example of FIG. 1, an E-UMTS may include a User Equipment (UE), eNode-Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARD)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Reference will now be made in detail to implementations of the present disclosure, examples of which are illustrated in the accompanying drawings. The detailed description, which will be given below with reference to the accompanying drawings, is intended to explain some examples of implementations of the present disclosure, rather than to show the only implementations that can be implemented according to the disclosure.

The following techniques, apparatuses, and systems may be applied to a variety of wireless multiple access systems. In some implementations, multiple access systems may include one or more of a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. In some implementations, CDMA may be implemented through radio technology such as universal terrestrial radio access (UTRA) or CDMA2000. In some implementations, TDMA may be implemented through radio technology such as global system for mobile communications (GSM), general packet radio service (GPRS), or enhanced data rates for GSM evolution (EDGE). In some implementations, OFDMA may be implemented through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, implementations of the present disclosure are described in regards to a 3GPP based wireless communication system. However, the technical features of the present disclosure are not limited thereto. For example, although the following detailed description is given based on a mobile communication system that implements a 3GPP based system, aspects of the present disclosure that are not limited to 3GPP based system are applicable to other mobile communication systems.

For example, implementations of the present disclosure are applicable to contention-based communication such as Wi-Fi as well as non-contention-based communication as in the 3GPP based system in which a BS allocates a DL/UL time/frequency resource to a UE and the UE receives a DL signal and transmits a UL signal according to resource allocation of the BS. In a non-contention-based communication scheme, an access point (AP) or a control node for controlling the AP allocates a resource for communication between the UE and the AP, whereas, in a contention-based communication scheme, a communication resource is occupied through contention between UEs which desire to access the AP.

An example of a contention-based communication scheme will now be described in brief. One type of the contention-based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”.

In some implementations, schemes for avoiding collision between transmitting devices in the contention-based communication system using CSMA may be implemented, such as carrier sense multiple access with collision detection (CSMA/CD) and/or carrier sense multiple access with collision avoidance (CSMA/CA).

For example, CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. When two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule.

As another example, CSMA/CA is a MAC protocol, which may be implemented according to the IEEE 802.11 standards. In some scenarios, a wireless LAN (WLAN) system, instead of using CSMA/CD, may implement CA, i.e. a collision avoidance, scheme. In some implementations, transmission devices always sense carrier of a network and, if the network is empty, the transmission devices wait for determined time according to locations thereof registered in a list and then transmit data. Various methods may be used to determine priority of the transmission devices in the list and to reconfigure priority. In some scenarios, collision may occur and, in this case, a collision sensing procedure is performed. A transmission device using CSMA/CA may help avoid collision between data transmission thereof and data transmission of another transmission device using a specific rule.

In the present disclosure, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present disclosure, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the EPC/LTE is referred to as an eNB, and a BS of the new radio (NR) system is referred to as a gNB.

In the present disclosure, a node refers to a fixed point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be a BS. For example, the node may be a radio remote head (RRH) or a radio remote unit (RRU). The RRH or RRU generally has a lower power level than a power level of a BS. Since the RRH or RRU (hereinafter, RRH/RRU) is generally connected to the BS through a dedicated line such as an optical cable, cooperative communication between RRH/RRU and the BS can be smoothly performed in comparison with cooperative communication between BSs connected by a radio line. At least one antenna is installed per node. The antenna may include a physical antenna or an antenna port or a virtual antenna.

In the present disclosure, a cell refers to a prescribed geographical area to which one or more nodes provide a communication service. Accordingly, in the present disclosure, communicating with a specific cell may include communicating with a BS or a node which provides a communication service to the specific cell. In addition, a DL/UL signal of a specific cell refers to a DL/UL signal from/to a BS or a node which provides a communication service to the specific cell. A node providing UL/DL communication services to a UE is called a serving node and a cell to which UL/DL communication services are provided by the serving node is especially called a serving cell.

In some scenarios, a 3GPP-based system implements a cell to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

In some scenarios, a 3GPP-based wireless communication system implements a cell to manage radio resources. The “cell” associated with the radio resources utilizes a combination of downlink resources and uplink resources, for example, a combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency may be a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell refers to a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

In the present disclosure, “PDCCH” refers to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present disclosure, monitoring a channel refers to attempting to decode the channel. For example, monitoring a PDCCH refers to attempting to decode PDCCH(s) (or PDCCH candidates).

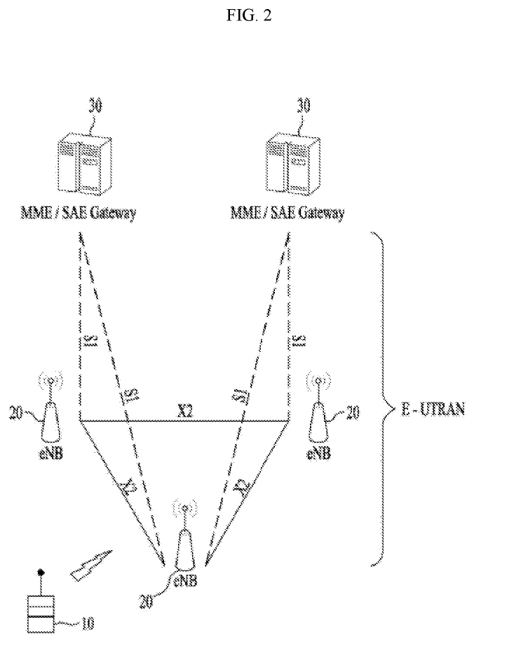

FIG. 2 is a block diagram illustrating an example of an evolved universal terrestrial radio access network (E-UTRAN). The E-UMTS may implement an LTE system. The communication network may be deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipments (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from BS 20 to UE 10, and “uplink” refers to communication from the UE to a BS.

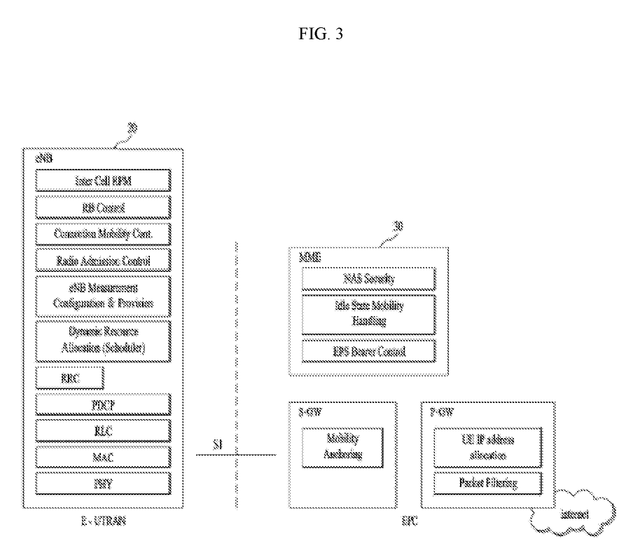

FIG. 3 is a block diagram depicting an example of an architecture of an E-UTRAN and an EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, access stratum (AS) Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity may include both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform various functions, such as selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE ACTIVE state. In the EPC, and as noted above, gateway 30 may perform various functions, such as paging origination, LTE-IDLE state management, ciphering of the user plane, System Architecture Evolution (SAE) bearer control, and ciphering and integrity protection of Non-Access Stratum (NAS) signaling.

The EPC may include a mobility management entity (MME), a serving-gateway (S-GW), and a packet data network-gateway (PDN-GW). The MME may have information about connections and capabilities of UEs, mainly for use in managing the mobility of the UEs. The S-GW is a gateway having the E-UTRAN as an end point, and the PDN-GW is a gateway having a packet data network (PDN) as an end point.

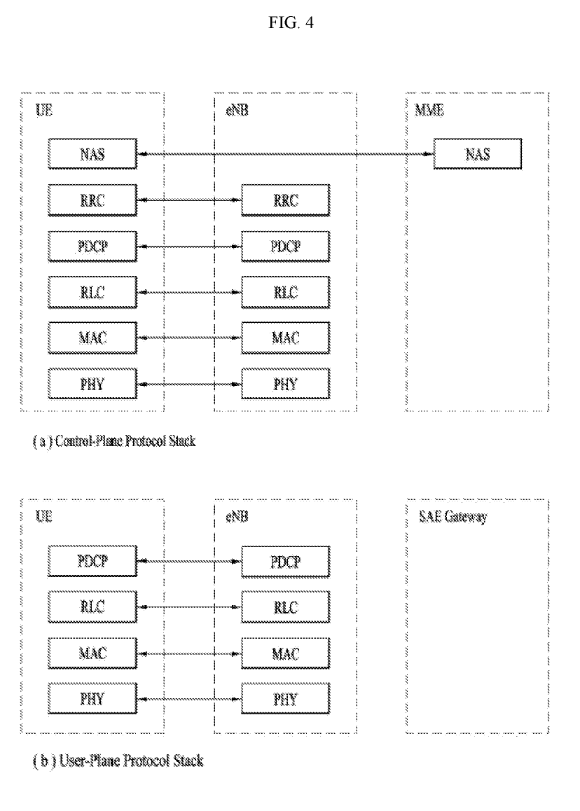

FIG. 4 is a diagram showing an example of a control plane and a user plane of a radio interface protocol between a UE and an E-UTRAN. Such an interface protocol may be implemented based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

In this example, Layer 1 (i.e. L1) of a system that can implement 3GPP LTE/LTE-A corresponds to a physical layer. A physical (PHY) layer of a first layer (Layer 1 or L1) provides an information transfer service to a higher layer using a physical channel. The PHY layer is connected to a medium access control (MAC) layer located at a higher layer. Data is transported between the MAC layer and the PHY layer via the transport channel. Data is transported between a physical layer of a transmitting side and a physical layer of a receiving side via physical channels. The physical channels use time and frequency as radio resources. In some implementations, the physical channel is modulated using an orthogonal frequency division multiple access (OFDMA) scheme in downlink and is modulated using a single carrier frequency division multiple access (SC-FDMA) scheme in uplink.

Also, in this example, Layer 2 (i.e. L2) of a system that can implement 3GPP LTE/LTE-A is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel. The RLC layer of the second layer may support reliable data transmission. In some implementations, a function of the RLC layer may be implemented by a functional block of the MAC layer. A packet data convergence protocol (PDCP) layer of the second layer performs a header compression function, which may reduce unnecessary control information for efficient transmission of an Internet protocol (IP) packet such as an IP version 4 (IPv4) packet or an IP version 6 (IPv6) packet in a radio interface having a relatively small bandwidth.

Examples of services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ; priority handling between logical channels of one UE; priority handling between UEs by dynamic scheduling; MBMS service identification; transport format selection; and padding.

Examples of services and functions of the RLC sublayer include: transfer of upper layer protocol data units (PDUs); error correction through ARQ (only for acknowledged mode (AM) data transfer); concatenation, segmentation and reassembly of RLC service data units (SDUs) (only for unacknowledged mode (UM) and acknowledged mode (AM) data transfer); re-segmentation of RLC data PDUs (only for AM data transfer); reordering of RLC data PDUs (only for UM and AM data transfer); duplicate detection (only for UM and AM data transfer); protocol error detection (only for AM data transfer); RLC SDU discard (only for UM and AM data transfer); and RLC re-establishment, except for a NB-IoT UE that only uses Control Plane CIoT EPS optimizations.

Examples of services and functions of the PDCP sublayer for the user plane include: header compression and decompression (ROHC only); transfer of user data; in-sequence delivery of upper layer PDUs at PDCP re-establishment procedure for RLC AM; for split bearers in DC and LWA bearers (only support for RLC AM), PDCP PDU routing for transmission and PDCP PDU reordering for reception; duplicate detection of lower layer SDUs at PDCP re-establishment procedure for RLC AM; retransmission of PDCP SDUs at handover and, for split bearers in DC and LWA bearers, of PDCP PDUs at PDCP data-recovery procedure, for RLC AM; ciphering and deciphering; timer-based SDU discard in uplink. Examples of services and functions of the PDCP for the control plane include: ciphering and integrity protection; and transfer of control plane data. For split and LWA bearers, PDCP supports routing and reordering. For DRBs mapped on RLC AM and for LWA bearers, the PDCP entity uses the reordering function when the PDCP entity is associated with two AM RLC entities, when the PDCP entity is configured for a LWA bearer; or when the PDCP entity is associated with one AM RLC entity after it was, according to the most recent reconfiguration, associated with two AM RLC entities or configured for a LWA bearer without performing PDCP re-establishment.

In this example, Layer 3 (i.e. L3) of a system that can implement LTE/LTE-A includes the following sublayers: Radio Resource Control (RRC) and Non Access Stratum (NAS). In some implementations, a radio resource control (RRC) layer located at the bottom of a third layer is defined only in the control plane. The RRC layer may control logical channels, transport channels, and physical channels in relation to configuration, re-configuration, and release of radio bearers (RBs). An RB refers to a service that the second layer provides for data transmission between the UE and the E-UTRAN. As such, the RRC layer of the UE and the RRC layer of the E-UTRAN exchange RRC messages with each other. The non-access stratum (NAS) layer positioned over the RRC layer performs functions such as session management and mobility management.

Radio bearers may be classified into (user) data radio bearers (DRBs) and signaling radio bearers (SRBs). In some implementations, SRBs are defined as radio bearers (RBs) that are used only for the transmission of RRC and NAS messages.

In some implementations, a system may be compatible with LTE, and one cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Examples of downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Examples of uplink transport channels for transmission of data from the UE to the E-UTRAN include a random access channel (RACH) for transmission of initial control messages and an uplink SCH for transmission of user traffic or control messages. Examples of logical channels that are defined above the transport channels and that are mapped to the transport channels include a broadcast control channel (BCCH), a paging control channel (PCCH), a common control channel (CCCH), a multicast control channel (MCCH), and a multicast traffic channel (MTCH).

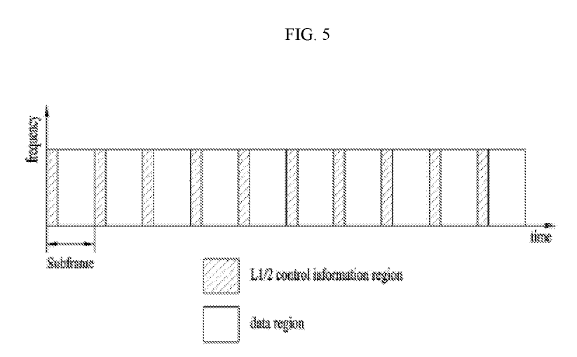

FIG. 5 is a diagram showing an example of a physical channel structure used in a system that may implement E-UMTS. A physical channel includes several subframes in a time domain (on a time axis) and several subcarriers in a frequency domain (on a frequency axis). In this example, one subframe includes a plurality of symbols on the time axis. One subframe includes a plurality of resource blocks and one resource block includes a plurality of symbols and a plurality of subcarriers. In some implementations, each subframe may use particular subcarriers of particular symbols (e.g., a first symbol) of a subframe for a physical downlink control channel (PDCCH), that is, an L1/L2 control channel. The PDCCH carries scheduling assignments and other control information.

In this example of FIG. 5, an L1/L2 control information transmission area (PDCCH) and a data area (PDSCH) are shown. In one implementation, a radio frame of 10 ms is used and one radio frame includes 10 subframes. In addition, for a system that is compatible with LTE, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A time interval in which one subframe is transmitted is defined as a transmission time interval (TTI). Different time resources may be distinguished by a radio frame number (or radio frame index), a subframe number (or subframe index), a slot number (or slot index), and the like. In general, TTI refers to an interval during which data may be scheduled. For example, in some scenarios, such as a system that implements 3GPP LTE/LTE-A, an opportunity of transmission of an UL grant or a DL grant is present every 1 ms, and the UL/DL grant opportunity is not provided with a time granularity of less than 1 ms. Therefore, in such scenarios, the TTI in implementations compatible with 3GPP LTE/LTE-A is 1 ms.

In some implementations, a base station and a UE transmit/receive data (excluding particular control signal or service data) via a PDSCH, which is a physical channel, using a downlink shared channel (DL-SCH) which is a transmission channel. Information indicating to which UE (one or a plurality of UEs) the PDSCH data is transmitted and how the UE receives and decodes PDSCH data is transmitted in a state of being included in the PDCCH.

For example, in some implementations, a particular PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a particular subframe. Then, one or more UEs located in a cell may monitor the PDCCH using its RNTI information. A specific UE with RNTI “A” may read the PDCCH and then receive the PDSCH indicated by “B” and “C” in the PDCCH information. In the present disclosure, a PDCCH addressed to an RNTI refers to the PDCCH being cyclic redundancy check masked (CRC-masked) with the RNTI. A UE may attempt to decode a PDCCH using the particular RNTI if the UE is monitoring a PDCCH addressed to the particular RNTI.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency, and cost efficiency. To meet the above ever-increasing requirements from market and mobile communication society, next generation access technologies are expected to emerge in the near future.

Building upon its success of IMT-2000 (3G) and IMT-Advanced (4G), 3GPP has been devoting its effort to IMT-2020 (5G) development. 5G New Radio (NR) is expected to expand and support diverse use case scenarios and applications that will continue beyond the current IMT-Advanced standard, for instance, enhanced Mobile Broadband (eMBB), Ultra Reliable Low Latency Communication (URLLC) and massive Machine Type Communication (mMTC). For example, eMBB is targeting high data rate mobile broadband services, such as seamless data access both indoors and outdoors, and AR/VR applications; URLLC is defined for applications that have stringent latency and reliability requirements, such as vehicular communications that can enable autonomous driving and control network in industrial plants; mMTC is the basis for connectivity in IoT, which allows for infrastructure management, environmental monitoring, and healthcare applications.

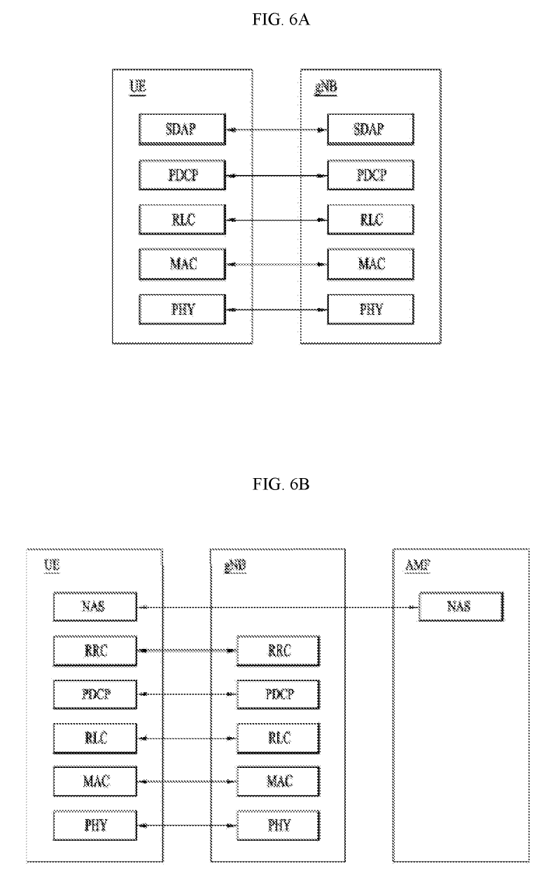

FIGS. 6A and 6B illustrate examples of protocol stacks of a next generation wireless communication system. In particular, FIG. 6A illustrates an example of a radio interface user plane protocol stack between a UE and a gNB, and FIG. 6B illustrates an example of a radio interface control plane protocol stack between a UE and a gNB.

The control plane refers to a path through which control messages used to manage call by a UE and a network are transported. The user plane refers to a path through which data generated in an application layer (e.g., voice data, Internet packet data, etc.) are transported.

Referring to the example in FIG. 6A, the user plane protocol stack may be divided into a first layer (Layer 1) (i.e., a physical layer (PHY) layer) and a second layer (Layer 2).

Referring to the example in FIG. 6B, the control plane protocol stack may be divided into Layer 1 (i.e., a PHY layer), Layer 2, Layer 3 (e.g., a radio resource control (RRC) layer), and a non-access stratum (NAS) layer.

The overall protocol stack architecture for the NR system is described next. In some implementations, RAN WG2 for NR is in charge of the radio interface architecture and protocols. Examples of the functionalities of the control plane may include the following: on-demand system information delivery to reduce energy consumption and mitigate interference, two-level (i.e. Radio Resource Control (RRC) and Medium Access Control (MAC)) mobility to implement seamless handover, beam based mobility management to accommodate high frequency, RRC inactive state to reduce state transition latency and improve UE battery life. Examples of the functionalities of the user plane may aim at latency reduction by optimizing existing functionalities, such as concatenation and reordering relocation, and RLC out of order delivery. In some scenarios, a user plane AS protocol layer named as Service Data Adaptation Protocol (SDAP) may be implemented to handle flow-based Quality of Service (QoS) framework in RAN, such as mapping between QoS flow and a data radio bearer, and QoS flow ID marking. Hereinafter, an example of the layer 2 for NR is briefly discussed.

The layer 2 of NR is split into the following sublayers: Medium Access Control (MAC), Radio Link Control (RLC), Packet Data Convergence Protocol (PDCP) and Service Data Adaptation Protocol (SDAP). The physical layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers, and the SDAP sublayer offers to 5GC QoS flows. Radio bearers are categorized into two groups: data radio bearers (DRB) for user plane data and signaling radio bearers (SRB) for control plane data.

Examples of services and functions of the MAC sublayer of NR include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per carrier in case of carrier aggregation); priority handling between UEs by dynamic scheduling; priority handling between logical channels of one UE by logical channel prioritization; and padding. A single MAC entity may support one or multiple numerologies and/or transmission timings, and mapping restrictions in logical channel prioritization controls which numerology and/or transmission timing a logical channel can use.

The RLC sublayer of NR supports three transmission modes: Transparent Mode (TM); Unacknowledged Mode (UM); Acknowledged Mode (AM). In some implementations, the RLC configuration is per logical channel with no dependency on numerologies and/or TTI durations, and ARQ can operate on any of the numerologies and/or TTI durations the logical channel is configured with. For SRB0, paging and broadcast system information, TM mode is used. For other SRBs AM mode used. For DRBs, either UM or AM mode are used. In some implementations, services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; Reassembly of SDU (AM and UM); duplicate detection (AM only); RLC SDU discard (AM and UM); RLC re-establishment; and protocol error detection (AM only). The ARQ within the RLC sublayer of NR has the following characteristics: ARQ retransmits RLC PDUs or RLC PDU segments based on RLC status reports; polling for RLC status report is used when needed by RLC; and RLC receiver can also trigger RLC status report after detecting a missing RLC PDU or RLC PDU segment.

Examples of services and functions of the PDCP sublayer of NR for the user plane include: sequence numbering; header compression and decompression (ROHC only); transfer of user data; reordering and duplicate detection; PDCP PDU routing (in case of split bearers); retransmission of PDCP SDUs; ciphering, deciphering and integrity protection; PDCP SDU discard; PDCP re-establishment and data recovery for RLC AM; and duplication of PDCP PDUs. Examples of services and functions of the PDCP sublayer of NR for the control plane include: sequence numbering; ciphering, deciphering and integrity protection; transfer of control plane data; reordering and duplicate detection; and duplication of PDCP PDUs.

Examples of services and functions of SDAP include: mapping between a QoS flow and a data radio bearer; marking QoS flow ID (QFI) in both DL and UL packets. A single protocol entity of SDAP may be configured for each individual PDU session. In some implementations, compared to some systems that may be bearer-based, implementations disclosed herein adopt the QoS flow-based framework. In some scenarios, such QoS flow-based framework enables flexible mapping of QoS flow to DRB by decoupling QoS flow and the radio bearer, allowing more flexible QoS characteristic configuration.

Examples of services and functions of RRC sublayer of NR include: broadcast of system information related to access stratum (AS) and non-access stratum (NAS); paging initiated by a 5GC or an NG-RAN; establishment, maintenance, and release of RRC connection between a UE and a NG-RAN (which further includes modification and release of carrier aggregation and further includes modification and release of the DC between an E-UTRAN and an NR or in the NR; a security function including key management; establishment, configuration, maintenance, and release of SRB(s) and DRB(s); handover and context transfer; UE cell selection and re-release and control of cell selection/re-selection; a mobility function including mobility between RATs; a QoS management function, UE measurement report, and report control; detection of radio link failure and discovery from radio link failure; and NAS message transfer to a UE from a NAS and NAS message transfer to the NAS from the UE.

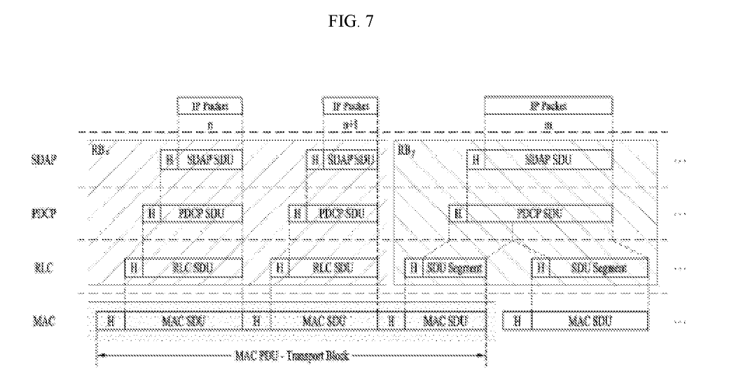

FIG. 7 illustrates a data flow example at a transmitting device in an NR system.

In FIG. 7, an RB denotes a radio bearer. Referring to the example of FIG. 7, a transport block is generated by MAC by concatenating two RLC PDUs from RBₓ and one RLC PDU from RB_{y}. In FIG. 7, the two RLC PDUs from RBₓ each corresponds to one IP packet (n and n+1) while the RLC PDU from RB_{y} is a segment of an IP packet (m). In NR, a RLC SDU segment can be located in the beginning part of a MAC PDU and/or in the ending part of the MAC PDU. The MAC PDU is transmitted/received using radio resources through a physical layer to/from an external device.

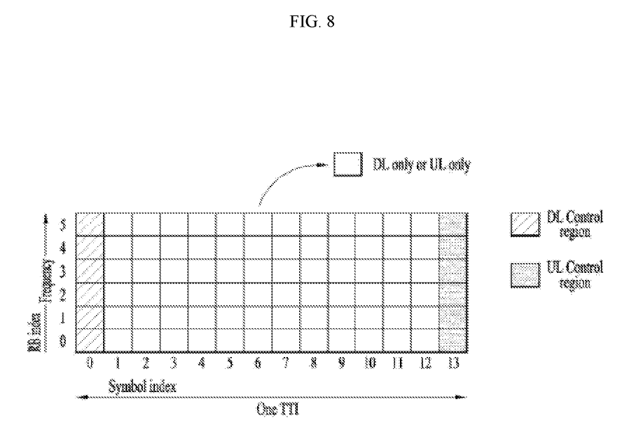

FIG. 8 illustrates an example of a slot structure available in a new radio access technology (NR).

In some implementations, a slot structure in which a control channel and a data channel are time-division-multiplexed is implemented. Such implementations may, in some scenarios, reduce or minimize data transmission latency in a 5G new RAT,

In the example of FIG. 8, the hatched area represents the transmission region of a DL control channel (e.g., PDCCH) carrying the DCI, and the shaded area represents the transmission region of a UL control channel (e.g., PUCCH) carrying the UCI. Here, the DCI is control information that the gNB transmits to the UE. The DCI may include, for example, information on cell configuration that the UE should know, DL specific information such as DL scheduling, and UL specific information such as UL grant. The UCI is control information that the UE transmits to the gNB. The UCI may include, for example, a HARQ ACK/NACK report on the DL data, a CSI report on the DL channel status, and a scheduling request (SR).

In the example of FIG. 8, the region of symbols from symbol index 1 to symbol index 12 may be used for transmission of a physical channel (e.g., a PDSCH) carrying downlink data, or may be used for transmission of a physical channel (e.g., PUSCH) carrying uplink data. According to the slot structure of FIG. 8, DL transmission and UL transmission may be sequentially performed in one slot, and thus transmission/reception of DL data and reception/transmission of UL ACK/NACK for the DL data may be performed in one slot. As a result, in some scenarios, the time taken to retransmit data when a data transmission error occurs may be reduced, thereby minimizing the latency of final data transmission.

In such a slot structure, a time gap may be implemented for the process of switching from the transmission mode to the reception mode or from the reception mode to the transmission mode of the gNB and UE. On behalf of the process of switching between the transmission mode and the reception mode, some OFDM symbols at the time of switching from DL to UL in the slot structure are set as a guard period (GP).

In some systems, a DL control channel is typically time-division-multiplexed with a data channel and a PDCCH, which is a control channel, is transmitted throughout an entire system band. However, according to some implementations disclosed herein, which may implement the new RAT, a bandwidth of one system may reach approximately a minimum of 100 MHz. As such, in some scenarios, it may be difficult to distribute the control channel throughout the entire band for transmission of the control channel. For data transmission/reception of a UE, if the entire band is monitored to receive the DL control channel, then this may cause increase in battery consumption of the UE and deterioration in efficiency. Accordingly, in some implementations of the present disclosure, the DL control channel may be locally transmitted or distributively transmitted in a partial frequency band in a system band, i.e., a channel band.

In the NR system, the basic transmission unit is a slot. A duration of the slot includes 14 symbols having a normal cyclic prefix (CP) or 12 symbols having an extended CP. In addition, the slot is scaled in time as a function of a used subcarrier spacing.

Hereinafter, when a PDCP Data PDU is received from lower layers, actions of the receiving PDCP entity are explained. For convenience of explanation, definitions of parameters are provided below.
HFN (State Variable): the HFN part (e.g., the number of most significant bits equal to HFN length) of the State Variable;
SN (State Variable): the SN part (e.g., the number of least significant bits equal to PDCP SN length) of the State Variable;
RCVD_SN: the PDCP SN of the received PDCP Data PDU, included in the PDU header;
RCVD_HFN: the HFN of the received PDCP Data PDU, calculated by the receiving PDCP entity;
RCVD_COUNT: the COUNT of the received PDCP Data PDU=[RCVD_HFN, RCVD_SN].

In some implementations, at reception of a PDCP Data PDU from lower layers, the receiving PDCP entity determines the COUNT value of the received PDCP Data PDU, i.e. RCVD_COUNT, as follows:
if RCVD_SN<SN(RX_DELIV)−Window_Size, then RCVD_HFN is set to HFN(RX_DELIV)+1.
else if RCVD_SN>=SN(RX_DELIV)+Window_Size . . . then RCVD_HFN is set to HFN(RX_DELIV)−1.
else, RCVD_HFN is set to HFN(RX_DELIV).

Finally, RCVD_COUNT is determined to [RCVD_HFN, RCVD_SN].

In some implementations, after determining the COUNT value of the received PDCP Data PDU, the receiving PDCP performs deciphering and integrity verification of the PDCP Data PDU using COUNT=RCVD_COUNT and discards the PDCP Data PDU if RCVD_COUNT<RX_DELIV or if the PDCP Data PDU with COUNT=RCVD_COUNT has been received before. When integrity verification fails, the receiving PDCP entity indicates the integrity verification failure to upper layers.

Otherwise, the receiving PDCP entity performs deciphering and integrity verification of the PDCP Data PDU using COUNT=RCVD_COUNT. When the integrity verification fails, the receiving PDCP entity indicates the integrity verification failure to upper layers and discards the PDCP Data PDU.

In some implementations, if the received PDCP Data PDU with COUNT value=RCVD_COUNT is not discarded above, then the receiving PDCP entity stores the resulting PDCP SDU in the reception buffer.

In such implementations, if RCVD_COUNT>=RX_NEXT, then the receiving PDCP entity updates RX_NEXT to RCVD_COUNT+1. Further, if outOfOrderDelivery is configured, then the receiving PDCP entity delivers the resulting PDCP SDU to upper layers.

In some implementations, if RCVD_COUNT=RX_DELIV, then the receiving PDCP entity delivers to upper layers, in ascending order of the associated COUNT value (after performing header decompression when not decompressed before), all stored PDCP SDU(s) with consecutively associated COUNT value(s) starting from COUNT=RX_DELIV. The receiving PDCP entity then updates RX_DELIV to the COUNT value of the first PDCP SDU which has not been delivered to upper layers, with COUNT value>RX_DELIV.

Furthermore, in some implementations, if a timer t-Reordering is running, and if RX_DELIV>=RX_REORD, then the receiving PDCP entity stops and resets the timer t-Reordering. If the timer t-Reordering is not running (which includes the scenario where t-Reordering is stopped due to actions above), and if RX_DELIV<RX_NEXT, then the receiving PDCP entity updates RX_REORD to RX_NEXT and start t-Reordering.

In some implementations, when t-Reordering expires, the receiving PDCP entity delivers to upper layers in ascending order of the associated COUNT value after performing header decompression, if not decompressed before all stored PDCP SDU(s) with associated COUNT value(s)<RX_REORD or all stored PDCP SDU(s) with consecutively associated COUNT value(s) starting from RX_REORD. Further, the receiving PDCP entity updates RX_DELIV to the COUNT value of the first PDCP SDU which has not been delivered to upper layers, with COUNT value>=RX_REORD.

In some implementations, if RX_DELIV<RX_NEXT, the receiving PDCP entity updates RX_REORD to RX_NEXT and start t-Reordering.

If the value of the timer t-Reordering is reconfigured by upper layers while the t-Reordering is running, then the UE updates RX_REORD to RX_NEXT. Further, the UE stops and restarts the timer t-Reordering.

Hereinafter, examples of integrity protection and verification are explained, although implementations are not necessarily limited to these examples.

In some implementations, the integrity protection function includes both integrity protection and integrity verification and is performed in PDCP, if configured. The data unit that is integrity protected is the PDU header and the data part of the PDU before ciphering. In some scenarios, the integrity protection is always applied to PDCP Data PDUs of SRBs. The integrity protection is applied to PDCP Data PDUs of DRBs for which integrity protection is configured. In some implementations, the integrity protection is not applicable to PDCP Control PDUs.

The integrity protection algorithm and key to be used by the PDCP entity are configured by upper layers. The integrity protection function is activated by upper layers. In some implementations, when security is activated, the integrity protection function is applied to all PDUs including and subsequent to the PDU indicated by upper layers for the downlink and the uplink, respectively.

For downlink and uplink integrity protection and verification, the parameters required by PDCP for integrity protection are input to the integrity protection algorithm. Examples of inputs to the integrity protection function include the COUNT value, and DIRECTION (direction of the transmission). Examples of parameters required by PDCP which are provided by upper layers are:
BEARER (defined as the radio bearer identifier. It will use the value RB identity−1);
KEY (the integrity protection keys for the control plane and for the user plane are KRRCint and KUPint, respectively).

At transmission, the UE computes the value of the MAC-I (Message Authentication Code for Integrity) field and at reception it verifies the integrity of the PDCP Data PDU by calculating the X-MAC (Computed MAC-I) based on the input parameters as specified above. If the calculated X-MAC corresponds to the received MAC-I, integrity protection is verified successfully.

In NR, a UE can support the integrity protection and verification for both DRBs and SRBs. For SRBs, when the integrity verification is failed, the UE performs the RRC connection re-establishment procedure. The integrity verification failure for SRBs is caused by security attack since the Hyper Frame Number (HFN) de-synchronization problem is usually incurred by the protocol error in case of high throughput.

For DRBs, there are two scenarios in which integrity verification may fail. One scenarios is a security attack, and another scenario is an HFN de-synchronization problem. However, the UE and network may not be aware whether the integrity verification failure is incurred by the security attack or the HFN de-synchronization. Compounding the difficulties, the solutions for each scenario may be different according to the cause.

To address such challenges, implementations disclosed herein enable a mechanism to decide whether the integrity verification failure is incurred by the security attack or the HFN de-synchronization.

According to implementations of the present disclosure, when the number of one or more integrity verification failures reaches a threshold value, a UE reports the integrity verification failure indication including the PDCP COUNT value(s) to the network. When the network receives the integrity verification failure indication, the network decides that the integrity verification failure is caused by the security attack or the HFN de-synchronization based on the PDCP COUNT value(s). After that, the network performs the proper procedure according to the cause. For example, the proper procedure may be the DRB release and setup procedure, the RRC connection re-establishment procedure, the RRC connection release procedure, or the RRC reconfiguration procedure.

The UE receives information to report the integrity verification failure from the network including a threshold number of integrity verification failures (e.g., NumFail). The NumFail threshold can be provided per a DRB or per a PDU session.

The UE maintains a counter to count the number of the integrity verification failure. Further, The UE resets the counter, when the DRB is established or re-established, or when the security key is changed, or when the PDU session is established or re-established, or when detecting the integrity verification success.

In some implementations, the UE does not reset the counter when the counter reaches the NumFail threshold. The UE increments the counter by 1 when an integrity verification failure occurs. The initial value of the counter can be configured by the network.

In some implementations, the UE manages the counter per DRB or per PDU session.

When the counter reaches the NumFail threshold, the UE sends the integrity verification failure indication to the network containing the integrity verification failure indication and/or the one or more DRB ID(s) associated with integrity verification failure indication. Further, the integrity verification failure indication may include a PDCP COUNT value associated with integrity verification failure indication or all PDCP COUNT values associated with integrity verification failure indication.

In some implementations, if the UE sends a COUNT value associated with integrity verification failure, the UE selects the COUNT value as follows:
the UE selects the lowest PDCP COUNT value among the PDCP COUNT values associated with integrity verification failure; or
the UE randomly selects the PDCP COUNT value among the PDCP COUNT values associated with integrity verification failure; or
UE selects the highest PDCP COUNT value among the PDCP COUNT values associated with integrity verification failure.

The integrity verification failure indication can be transmitted by various techniques, such as by RRC signaling or PDCP Control PDU.

When the network receives the integrity verification failure indication, in some implementations the network compares the PDCP COUNT value(s) in the integrity verification failure indication to the PDCP COUNT value(s) which has been transmitted by the network.

In this example, if the PDCP COUNT value(s) in the integrity verification failure indication is different with the PDCP COUNT values which been transmitted by the network, indicating HFN de-synchronization, then the network performs the DRB release and setup procedure for the DRBs using the DRB ID(s) included by the integrity verification failure indication.

Otherwise, if the PDCP COUNT value(s) in the integrity verification failure indication is same with the PDCP COUNT values which have been transmitted by the network, indicating a security attack, then the network performs the RRC connection re-establishment procedure or the RRC connection release procedure or the RRC reconfiguration procedure.

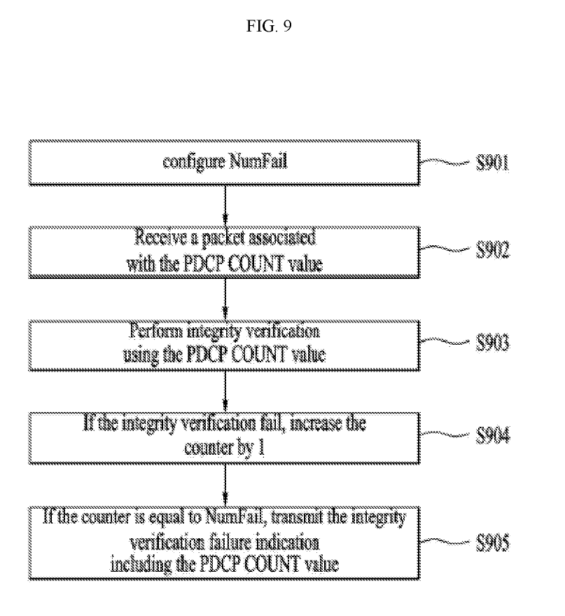

FIG. 9 is a flow chart showing an example for performing integrity verification in a wireless communication system according to the implementations of the present disclosure. In particular, the example in FIG. 9 illustrates an example of an integrity verification incurred by HFN De-sync.

Firstly, in S901, the UE receives the configuration messages from a network. By using these messages, the integrity function is configured with a threshold (e.g., NumFail) set to 3. Next, in S902, the UE receives a packet associated with the PDCP COUNT value (100) from the network.

Then, upon receiving the packet, the UE performs the integrity verification using the PDCP COUNT value (1000), in S903. And, if the integrity verification fails, then the UE increments the counter by 1. (i.e., counter=1 in this example) in S904.

The UE compares the counter (i.e., 1 in this example) to the NumFail threshold (i.e., 3 in this example). Since the counter is not equal to the NumFail threshold, the integrity verification failure is not transmitted.

The network transmits a packet associated with COUNT value (101) to the UE. Upon receiving the packet, the UE performs the integrity verification using the PDCP COUNT value (1001). If the integrity verification fails, then the UE increments the counter by 1. (i.e., counter=2 in this example)

The UE then receives a packet associated with the PDCP COUNT value (102) from the network. The UE performs the integrity verification using the PDCP COUNT value (1002). If the integrity verification fails, then the UE increments the counter by 1. (i.e., counter=3 in this example). Since the counter is equal to NumFail threshold of 3 in this example, the UE transmits the integrity verification failure indication including the PDCP COUNT value (1002), in S905.

When receiving the integrity verification failure indication, network compares the PDCP COUNT value (1002) to the PDCP COUNT values (e.g., 100, 101, 102) which have been transmitted. The network decides that the integrity verification failure is caused by the HFN de-synchronization since there is no matching COUNT value. Consequently, the network performs the DRB release and setup procedure.

Hereinafter, another example is presented for a scenario in which the integrity verification is incurred by security attack. For convenience of explanation, the example of FIG. 9 is reused.

In S901, the UE receives the configuration messages from a network. By using these messages, the integrity function is configured with the NumFail threshold set to 3. Next, in S902, the UE receives a packet associated with the PDCP COUNT value (100) from the network.

Then, upon receiving the packet, the UE performs the integrity verification using the PDCP COUNT value (100), in S903.I If the integrity verification fails, then the UE increments the counter by 1. (i.e., counter=1 in this example) in S904.

The UE compares the counter (i.e., 1 in this example) to the NumFail threshold (i.e., 3 in this example). Since the counter is not equal to the NumFail threshold, the integrity verification failure is not transmitted.

The network transmits a packet associated with COUNT value (101) to the UE. Upon receiving the packet, the UE performs the integrity verification using the PDCP COUNT value (101). If the integrity verification fails, then the UE increments the counter by 1 (i.e., counter=2 in this example).

The UE then receives a packet associated with the PDCP COUNT value (102) from the network. The UE performs the integrity verification using the PDCP COUNT value (102). If the integrity verification fails, then the UE increments the counter by 1 (i.e., counter=3 in this example). Since the counter is equal to the NumFail threshold in this example, the UE transmits the integrity verification failure indication including the PDCP COUNT value (102), in S905.

When receiving the integrity verification failure indication, network compares the PDCP COUNT value (102) to the PDCP COUNT values (e.g., 100, 101, 102) which have been transmitted. Consequently, the network decides that the integrity verification failure is caused by the security attack since there is a matching COUNT value, and performs the RRC connection release procedure.

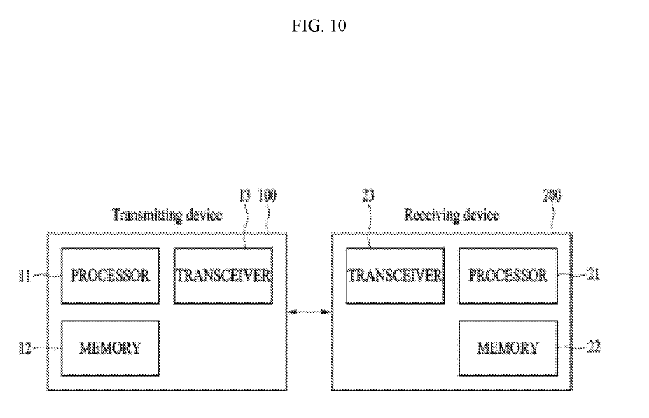

FIG. 10 is a block diagram illustrating an example of elements of a transmitting device 100 and a receiving device 200 according to some implementations of the present disclosure.

The transmitting device 100 and the receiving device 200 respectively include transceivers 13 and 23 configured to transmit and receive radio signals carrying information, data, signals, and/or messages. The transmitting device 100 and the receiving device 200 also respectively include at least one computer memory, such as memories 12 and 22, for storing information related to communication in a wireless communication system, and at least one processor, such as processors 11 and 21, that are operationally connected to elements such as the transceivers 13 and 23 and the memories 12 and 22 to control the elements and configured to control the memories 12 and 22 and/or the transceivers 13 and 23 so that a corresponding device may perform at least one of the above-described implementations of the present disclosure.

The memories 12 and 22 may store programs for processing and controlling the processors 11 and 21 and may temporarily store input/output information. The memories 12 and 22 may be used as buffers. For example, buffers at each protocol layer (e.g. PDCP, RLC, MAC) may be parts of the memories 12 and 22.

Each of the processors 11 and 21 may include one or more processing components that are localized or distributed. The processors 11 and 21 may generally control the overall operation of various modules in the transmitting device and the receiving device. In particular, the processors 11 and 21 may perform various control functions to implement the present disclosure. For example, the operations occurring at the protocol stacks (e.g., PDCP, RLC, MAC and PHY layers) according to the present disclosure may be performed by the processors 11 and 21. The protocol stacks performing operations of the present disclosure may be parts of the processors 11 and 21.

The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. The present disclosure may be implemented using firmware or software, and the firmware or software may be configured to include modules, procedures, functions, etc. performing the functions or operations of the present disclosure. Firmware or software configured to perform the present disclosure may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the transceiver 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transceiver 13 may include an oscillator. The transceiver 13 may include Nₜ (where Nₜ is a positive integer) transmission antennas.

In some implementations, a signal processing process of the receiving device 200 is the reverse of the signal processing process of the transmitting device 100. Under control of the processor 21, the transceiver 23 of the receiving device 200 receives radio signals transmitted by the transmitting device 100. The transceiver 23 may include Nᵣ (where Nᵣ is a positive integer) receive antennas and frequency down-converts each signal received through receive antennas into a baseband signal. The processor 21 decodes and demodulates the radio signals received through the reception antennas and restores data that the transmitting device 100 intended to transmit.

The transceivers 13 and 23 include one or more antennas. An antenna performs a function for transmitting signals processed by the transceivers 13 and 23 to the exterior or receiving radio signals from the exterior to transfer the radio signals to the transceivers 13 and 23. In some implementations, the antenna may also be referred to as an antenna port. Each antenna may correspond to one physical antenna or may be configured by a combination of more than one physical antenna element. In some scenarios, the signal transmitted from each antenna cannot be further deconstructed by the receiving device 200. In some implementations, a signal transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. In such implementations, an antenna is implemented such that a channel carrying a symbol of the antenna can be obtained from a channel carrying another symbol of the same antenna. A transceiver supporting a MIMO function of transmitting and receiving data using a plurality of antennas may be connected to two or more antennas. The transceivers 13 and 23 may be referred to as radio frequency (RF) units.

In some implementations of the present disclosure, a UE operates as the transmitting device 100 in uplink (UL) operations and as the receiving device 200 in downlink (DL) operations. In some implementations of the present disclosure, a BS operates as the receiving device 200 in UL and as the transmitting device 100 in DL. Hereinafter, a processor, a transceiver, and a memory included in the UE will be referred to as a UE processor, a UE transceiver, and a UE memory, respectively, and a processor, a transceiver, and a memory included in the BS will be referred to as a BS processor, a BS transceiver, and a BS memory, respectively.

The UE processor can be configured to operate according to the present disclosure, or control the UE transceiver to receive or transmit signals according to the present disclosure. The BS processor can be configured to operate according to the present disclosure, or control the BS transceiver to receive or transmit signals according to the present disclosure.

In some implementations, the processor 11 (at a UE and/or at a BS) checks whether there is a UL grant or DL assignment for a serving cell in a time unit. If there is a UL grant or DL assignment for the serving cell in the time unit, the processor 11 checks whether a data unit is actually present on the UL grant or DL assignment in the time unit, in order to determine whether to restart a deactivation timer associated with the serving cell which has been started. The processor 11 restarts the deactivation timer associated with the serving cell in the time unit if there is a data unit present on the UL grant or DL assignment in the time unit. The processor 11 does not restart the deactivation timer associated with the serving cell in the time unit if there is no data unit present on the UL grant or DL assignment in the time unit, unless another condition for the processor 11 to restart the deactivation timer is satisfied. The processor 11 does not restart the deactivation timer associated with the serving cell in the time unit if there is no data unit present on the UL grant or DL assignment in the time unit and if an activation command for activating the serving cell is not present in the time unit. The processor 11 may be configured to check whether a data unit is actually present on the UL grant or DL assignment on the serving cell in the time unit in order to determine whether to restart the deactivation timer of the serving cell, if the UL grant or DL assignment is a configured grant/assignment which is configured by RRC to occur periodically on the serving cell. The processor 11 may be configured to check whether a data unit is actually present on the UL grant or DL assignment on the serving cell in the time unit in order to determine whether to restart the deactivation timer of the serving cell, if the UL grant or the DL assignment is a dynamic grant/assignment which is indicated by a PDCCH. The processor 11 may be configured to check whether a data unit is actually present on the UL grant or DL assignment on the serving cell in the time unit in order to determine whether to restart the deactivation timer of the serving cell, if the serving cell is a SCell of the UE. The processor 11 (at the UE and/or the BS) deactivates the serving cell upon expiry of the deactivation timer associated with the serving cell.

As described above, a detailed description of examples of some implementations of the present disclosure has been given to enable those skilled in the art to implement and practice the disclosure. Although the disclosure has been described with reference to various implementations, those skilled in the art will appreciate that various modifications and variations can be made in the present disclosure without departing from the spirit or scope of the disclosure described in the appended claims. Accordingly, the disclosure should not be limited to the specific implementations described herein, but should be accorded the broadest scope consistent with the principles and novel features disclosed herein.

### INDUSTRIAL APPLICABILITY

The implementations of the present disclosure are applicable to a network node (e.g., BS), a UE, or other devices in a wireless communication system.

1. A method of reporting integrity verification failure by a user equipment (UE) in a wireless communication system, the method comprising:
receiving a data unit from a network;
performing integrity verification using the data unit; and
reporting information about the integrity verification failure to the network when the integrity verification fails,
wherein the information about the integrity verification failure comprises (i) a radio bearer identity associated with the integrity verification failure, and (ii) at least one Packet Data Convergence Protocol (PDCP) COUNT value associated with the radio bearer identity.

2. The method of claim 1, further comprising:
incrementing a counter when the integrity verification failure occurs,
wherein reporting the information about the integrity verification failure comprises reporting the information about the integrity verification failure to the network when the counter is equal to a threshold value.

3. The method of claim 2, further comprising receiving information about the threshold value from the network.

4. The method of claim 1, wherein the information about the integrity verification failure comprises (i) at least one radio bearer identity, including the radio bearer identity, associated with the integrity verification failure, and (ii) at least one PDCP COUNT value, including the PDCP COUNT value, associated with the at least one radio bearer identity.

5. The method of claim 4, wherein a cause of the integrity verification failure is determined by the network based on the at least one PDCP COUNT value reported by the UE.

6. The method of claim 1, wherein receiving the data unit from the network comprises:
receiving, through a lower layer of the UE, a PDCP protocol data unit (PDU).

7. The method of claim 1, wherein performing the integrity verification using the data unit comprises:
determining a first value corresponding to a field of the data unit that was received from the network;
computing a second value based on at least one parameter provided by upper layers of the UE;
comparing the first value with the second value; and
determining whether the integrity verification failure has occurred based on whether the first value is equal to the second value.

8. The method of claim 7, wherein the first value is a value of a Message Authentication Code for Integrity (MAC-I) field of the data unit that was received from the network, and
wherein the second value is a value of a computed MAC-I (X-MAC).

9. The method of claim 8, wherein computing the second value based on the at least one parameter provided by the upper layers of the UE comprises:
computing the value of the X-MAC based on at least one radio bearer identity and at least one key that are provided by the upper layers of the UE.

10. A user equipment (UE) configured to operate in a wireless communication system, the UE comprising:
a transceiver;
at least one processor; and
at least one computer memory operably connectable to the at least one processor and storing instructions that, when executed, cause the at least one processor to perform operations comprising:
receiving, through the transceiver, a data unit from a network;
performing integrity verification using the data unit; and
when the integrity verification fails, reporting information about an integrity verification failure to the network through the transceiver,
wherein the information about the integrity verification failure comprises (i) a radio bearer identity associated with the integrity verification failure, and (ii) at least one Packet Data Convergence Protocol (PDCP) COUNT value associated with the radio bearer identity.

11. The UE of claim 10, wherein the operations further comprise:
incrementing a counter when the integrity verification failure occurs,
wherein reporting the information about the integrity verification failure comprises reporting the information about the integrity verification failure to the network when the counter is equal to a threshold value.

12. The UE of claim 11, wherein the operations further comprise:
receiving information about the threshold value from the network.

13. The UE of claim 10, wherein the information about the integrity verification failure comprises (i) at least one radio bearer identity, including the radio bearer identity, associated with the integrity verification failure, and (ii) at least one PDCP COUNT value, including the PDCP COUNT value, associated with the at least one radio bearer identity.

14. The UE of claim 13, wherein a cause of the integrity verification failure is determined by the network based on the at least one PDCP COUNT value reported by the UE.

15. The UE of claim 10, wherein receiving the data unit from the network comprises:
receiving, through a lower layer of the UE, a PDCP protocol data unit (PDU).

16. The UE of claim 10, wherein performing the integrity verification using the data unit comprises:
determining a first value corresponding to a field of the data unit that was received from the network;
computing a second value based on at least one parameter provided by upper layers of the UE;
comparing the first value with the second value; and
determining whether the integrity verification failure has occurred based on whether the first value is equal to the second value.

17. The UE of claim 16, wherein the first value is a value of a Message Authentication Code for Integrity (MAC-I) field of the data unit that was received from the network, and
wherein the second value is a value of a computed MAC-I (X-MAC).

18. The UE of claim 17, wherein computing the second value based on the at least one parameter provided by the upper layers of the UE comprises:
computing the value of the X-MAC based on at least one radio bearer identity and at least one key that are provided by the upper layers of the UE.
